(19) United States
(12) Patent Application Publication
(10) Pub. No.: US 2022/0366429 A1
(43) Pub. Date: Nov. 17, 2022

(54) CRYPTOGRAPHICALLY SECURE SCANNABLE CODE TO DETERMINE THE AUTHENTICITY OF PHYSICAL ITEMS

(71) Applicants: Prakash Pati, Allen, TX (US); Akshaya Mahapatra, San Jose, CA (US)

(72) Inventors: Prakash Pati, Allen, TX (US); Akshaya Mahapatra, San Jose, CA (US)

(21) Appl. No.: 17/320,796

(22) Filed: May 14, 2021

(51) Int. Cl. G06Q 30/00; H04L 9/32; G06K 7/14; G06Q 30/02

(52) U.S. Cl. CPC G06Q 30/018; H04L 9/3247; H04L 9/3226; G06K 7/1417; G06Q 30/012; G06Q 30/0282; G06Q 30/014

(57) ABSTRACT

A system for determining authenticity of an item includes a processor and a memory. The memory includes instructions stored thereon, which when executed by the processor cause the system to assign a unique identifier to an item, generate a digital signature of the unique identifier of the item using a private key of a producing organization, generate a scannable code based on the generated digital signature and/or a base 64 encoded form of the generated digital signature, and embed in the item the scannable code and the unique item identifier, a name of the producing organization, and/or a public key server URL.

### TECHNICAL FIELD

This disclosure relates to relates to the application of cryptography, especially the use of asymmetric encryption and digital signature algorithms to determine the authenticity of physical items.

### BACKGROUND

Corporations lose revenue and tarnish their reputation due to counterfeit items sold in many parts of the world. Sometimes sensitive documents such as identification documents and currency are also counterfeited. The countermeasure to detect such can be complex and often involves the usage of specialized equipment.

### SUMMARY

In an aspect of the present disclosure, a system for determining authenticity of an item includes a processor and a memory. The memory includes instructions stored thereon, which when executed by the processor cause the system to assign a unique identifier to an item, generate a digital signature of the unique identifier of the item using a private key of a producing organization, generate a scannable code based on the generated digital signature and/or a base 64 encoded form of the generated digital signature, and embed in the item the scannable code and the unique item identifier, a name of the producing organization, and/or a public key server URL.

In another aspect of the present disclosure, the instructions, when executed by the processor, may further cause the system to: scan the scannable code by a user device, download the public key of the producing organization from a public key server, and determine, based on the public key, if the digital signature indicates an authentic item or not an authentic item.

In yet another aspect of the present disclosure, in a case where the digital signature indicates that the item is authentic, the instructions, when executed by the processor, may further cause the system to display an indication that the item is authentically produced by the producing organization.

In an aspect of the present disclosure, in a case where the digital signature indicates that the item is not authentic, the instructions, when executed by the processor, may further cause the system to display an indication that the item is not authentically produced by the producing organization.

In another aspect of the present disclosure, embedding in the item the scannable code may include printing the scannable code and/or etching the scannable code on the item and/or on packaging of the item.

In yet another aspect of the present disclosure, the instructions, when executed by the processor, may further cause the system to scan the code using the user device to take ownership of the item and apply for a warranty with a single button click of the user device.

In a further aspect of the present disclosure, the instructions, when executed by the processor, may further cause the system to scan the code using the user device to initiate at least one of a product review or complaint of the item.

In another aspect of the present disclosure, the instructions, when executed by the processor, may further cause the system to receiving item-specific notifications such as recall notices on the user device.

In yet another aspect of the present disclosure, the unique identifier may include a GUID (globally unique identifier).

In another aspect of the present disclosure, the item may include packaged food, identification documents, voting ballot, and/or currency.

In an aspect of the present disclosure, a computer-implemented method for determining authenticity of an item includes assigning a unique identifier to an item, generating a digital signature of the unique identifier of the item using a private key of a producing organization, generating a scannable code based on at least one of the generated digital signature or a base 64 encoded form of the generated digital signature, and embedding in the item the scannable code and at least one of the unique item identifier, a name of the producing organization, or a public key server URL.

In a further aspect of the present disclosure, the method may further include scanning the scannable code by a user device, downloading the public key of the producing organization from a public key server, and determining, based on the public key, if the digital signature indicates an authentic item or not an authentic item.

In an aspect of the present disclosure, the method may further include in a case where the digital signature indicates that the item is authentic, displaying an indication that the item is authentically produced by the producing organization.

In an aspect of the present disclosure, the method may further include in a case where the digital signature indicates that the item is not authentic, displaying an indication that the item is not authentically produced by the producing organization.

In another aspect of the present disclosure, embedding in the item the scannable code may include printing the scannable code and/or etching the scannable code on the item and/or on packaging of the item.

In yet another aspect of the present disclosure, the method may further include scanning the code using the user device to take ownership of the item and applying for a warranty with a single button click of the user device.

In an aspect of the present disclosure, the method may further include scanning the code using the user device to initiate at least one of a product review or complaint of the item.

In another aspect of the present disclosure, the method may further include receiving item-specific notifications such as recall notices on the user device.

In yet another aspect of the present disclosure, the unique identifier may include a GUID (globally unique identifier).

In an aspect of the present disclosure, a non-transitory computer-readable medium storing instructions that, when executed by a processor, cause the processor to perform a method for determining authenticity of an item is presented. The method includes assigning a unique identifier to an item, generating a digital signature of the unique identifier of the item using a private key of a producing organization, generating a scannable code based on at least one of the generated digital signature or a base 64 encoded form of the generated digital signature, and embedding in the item the scannable code and at least one of the unique item identifier, a name of the producing organization, or a public key server URL.

In an aspect of the present disclosure, the instructions, when executed by the processor, may further cause the system to upload to a database a time of the scan, a location of the scan, and the unique identifier of the scanned scannable code, wherein the scannable code is associated with a first item, scan a second item associated with the same scannable code by a user device, and provide an warning that the same scannable code was associated with a first item.

Other aspects, features, and advantages will be apparent from the description, the drawings, and the claims that follow.

### BRIEF DESCRIPTION OF DRAWINGS

The accompanying drawings, which are incorporated in and constitute a part of this specification, illustrate aspects of the disclosure and, together with a general description of the disclosure given above and the detailed description given below, serve to explain the principles of this disclosure, wherein:

FIG. 1 is a layout of a cryptographically secure scannable code such as a QR code, and a PDF 147 code, along with additional meta-data related to the disclosure; and

FIG. 2 is a block diagram of a work flow of the technology of the disclosure;

### DETAILED DESCRIPTION

Aspects of the disclosed monitoring systems are described in detail with reference to the drawings, in which like reference numerals designate identical or corresponding elements in each of the several views.

In the following description, well-known functions or constructions are not described in detail to avoid obscuring the present disclosure in unnecessary detail.

The producer or manufacturer of items assigns a unique identifier (e.g., a unique item number) for each of the items produced. Example items may include but are not limited to merchandise, official documents, to name a few. A digital signature of this unique identifier is computed using the private key of the Manufacturer and a standard PKI digital signature algorithm such as DSA. This digital signature or, optionally, the time-stamped digital signature is converted to a QR code and printed or embedded on the physical item along with the unique serial number of the item. This label can be scanned using a smartphone and related software available to the consumer (or the end-user) to validate the signature based on the unique serial number. This information can be uploaded to a public cloud for additional validation and analytics.

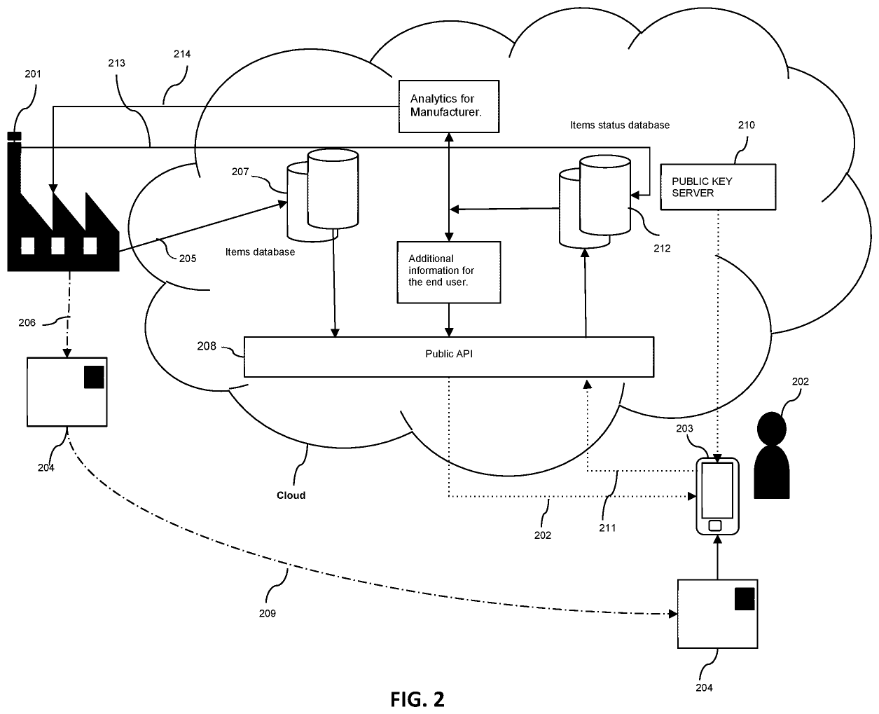

Referring to FIG. 2, there is shown a flow chart of an exemplary computer-implemented method for determining the authenticity of items based on a cryptographically secure code in accordance with aspects of the present disclosure. Although the steps of FIG. 2 are shown in a particular order, the steps need not all be performed in the specified order, and certain steps can be performed in another order. For simplicity, FIG. 2 will be described below, with the controller performing the operations. However, in various aspects, the operations of FIG. 2 may be performed in part by the controller and in part by another device, such as a remote server. These variations are contemplated to be within the scope of the present disclosure.

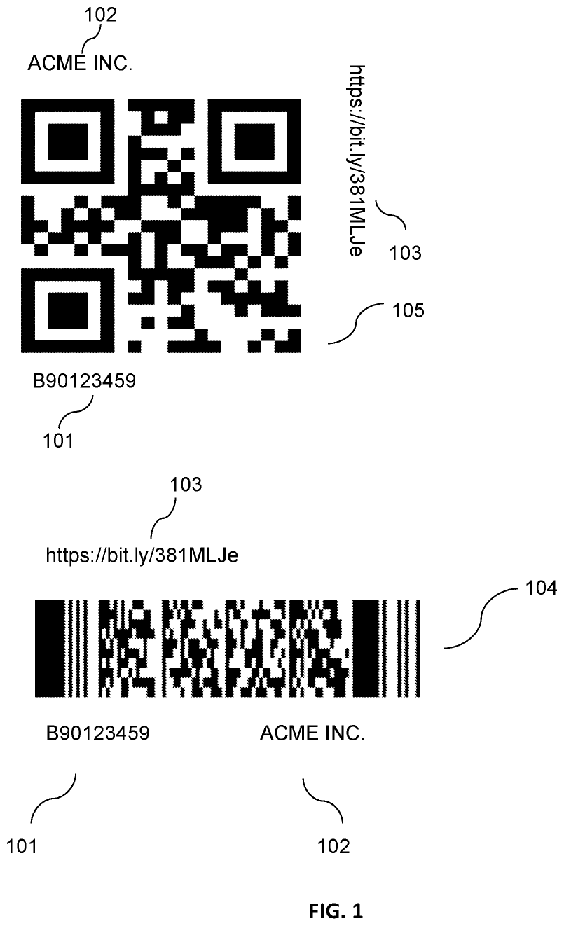

Initially, the controller assigns a unique identifier 101 (FIG. 1) such as, but not limited to, a GUID (globally Unique Identifier) to each item 204 being produced. The items 204 can be, but are not limited to, for example, physical items such as packaged food and/or documentation such as identification documents, voting ballot, or currency.

Next, the controller computes a digital signature of the unique number of the item 204 using the private key of the producing organization 201 or the manufacturer. The digital signature is computed using a standard public algorithm such as DSA. This signature can optionally be time-stamped.

Next, the controller generates a scannable code such as a QR code 105 or a PDF-147 104 or any other suitable code using the produced binary data or the base 64 encoded form of the produced binary data (FIG. 1).

The scannable code (e.g., QR code 105), along with the unique identifier 101, and other optional items such as the organization name 102 and a public key server URL 103 (FIG. 1) are embedded in the physical item 204. For example, the unique identifier 101 can be embedded in the form of a label, which can be printed and affixed in the packaging, or printed in the original document, or etched into the item body 206.

The unique identifier, along with other information such as the product description, Manufacturer, UPC code, is uploaded 205 to an items database 207 in the cloud. This information is accessible through a public interface. The public interface can be an Application Programming Interface 208 endpoint. The physical items can be shipped or distributed 209 to the consumers 202 as per a normal business flow.

The end-user or consumer 202 of the product can validate product authenticity using a user device 203 such as a smartphone and verification software to validate product authenticity.

The user device 203 may use the smartphone camera to scan the QR code. For example, the user device 203 may use OCR capabilities of the smart phone to convert the associated data such as the unique number, organization name, or the key server URL to text for internal use.

Next, the user device 203 will use the key server URL to download the public key of the producing organization from the Public Key Server 210. Optionally the user device may prepackage known public keys to eliminate this download.

The user device will use the public key to verify the digital signature from the item's unique identifier 101 embedded as part of the QR code. The digital signature is validated using a standard public algorithm such as DSA. A valid digital signature indicates the label is indeed authentically produced by the producing organization 201 (and/or manufacturer). The current location along with scan results, may be uploaded to the cloud 211) into an items status database 212.

The user device 203 may also pull additional information related to the item being scanned and displays it to the user. The additional information is uploaded 213 by the manufacturer to the items status database 212. The additional information may include recalls, known support issues, or validity of the item.

The scanning activity, physical location, and time of the scan can be analyzed using machine learning to detect unusual activities related to the item and warn the end-user/Producer about potential forgery. As an example, the same unique identifier scanned across different locations in a short time indicates a forged item.

The scanned data can provide meaningful analytics 214 to the manufacturer, such as the product's geographical migration, ownership claim, etc.

Even though this invention is related to detecting authenticity, this technique has other unrelated applications worth mentioning. After scanning the items' QR code as an example, the end-users should be able to perform additional item-specific operations with ease. Example of such operations may include: registering the product with the manufacturer or claim ownership; getting connected with the product support; read or write a review of the product; viewing product recalls; and/or complaining about the product.

In aspects, a digital signature plus the unique serial number can be used by the system to determine the authenticity. According to the present disclosure, a user can use a handheld device and detect a forged item quickly and reliably. The disclosed systems and methods make it impossible for a forger to create a signature with fake serial numbers. The systems and methods may enable uploading a scan result with location and time stamp for further verification. For example, if the same serial number is scanned in two different geolocations at the same time, the system can determine that one of the two items is a fake or counterfeit.

For example, in a case where the label itself is copied by the forger across multiple items, a local scan by a user device can validate the item to be authentic (or not). The uploaded scanned data to the cloud may be used to detect a copied/forged label based on scan location, time of the scan, and the item's serial number using a proprietary algorithm.

Moreover, the disclosed structure can include any suitable mechanical and/or electrical, components for operating the disclosed system or components thereof. For instance, such electrical components can include, for example, any suitable electrical and/or electromechanical, and/or electrochemical circuitry, which may include or be coupled to one or more printed circuit boards. As used herein, the term “controller” includes “processor,” “digital processing device” and like terms, and are used to indicate a microprocessor or central processing unit (CPU). The CPU is the electronic circuitry within a computer that carries out the instructions of a computer program by performing the basic arithmetic, logical, control and input/output (I/O) operations specified by the instructions, and by way of non-limiting examples, include server computers. In some aspects, the controller includes an operating system configured to perform executable instructions. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud computing-based storage. In various aspects, the storage and/or memory device is a combination of devices such as those disclosed herein.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the system, components thereof, and/or resources thereof. As used herein, the term “network” can include any network technology including, for instance, a cellular data network, a wired network, a fiber optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The machine learning (“ML”) model may be the most efficient for complex failures. However, basic logic can be used for simpler failure modes. Likely signals of abnormal operation may come from increases in energy required to move the irrigation system, changes in speed of the system, or changes in sequence of the towers moving, end gun turn frequency, or power quality metrics such as phase balance, inrush current, power factor, THD. Since these vary with a complex inference space, ML can assist in predicting abnormal operation and simplify user and subject matter expert input by giving a simple labeling method.

As can be appreciated, securement of any of the components of the disclosed apparatus can be effectuated using known securement techniques such welding, crimping, gluing, fastening, etc.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A system for determining authenticity of an item, the system comprising:
a processor; and
a memory, including instructions stored thereon, which when executed by the processor cause the system to:
assign a unique identifier to an item;
generate a digital signature of the unique identifier of the item using a private key of a producing organization;
generate a scannable code based on at least one of the generated digital signature or a base 64 encoded form of the generated digital signature; and
embed in the item the scannable code and at least one of the unique item identifier, a name of the producing organization, or a public key server URL.

2. The system of claim 1, wherein the instructions, when executed by the processor, further cause the system to:
scan the scannable code by a user device;
download the public key of the producing organization from a public key server; and
determine, based on the public key, if the digital signature indicates an authentic item or not an authentic item.

3. The system of claim 2, wherein in a case where the digital signature indicates that the item is authentic, the instructions, when executed by the processor, further cause the system to:
display an indication that the item is authentically produced by the producing organization.

4. The system of claim 2, wherein in a case where the digital signature indicates that the item is not authentic, the instructions, when executed by the processor, further cause the system to:
display an indication that the item is not authentically produced by the producing organization.

5. The system of claim 1, wherein embedding in the item the scannable code includes at least one of printing the scannable code and/or etching the scannable code on the item and/or on packaging of the item.

6. The system of claim 2, wherein the instructions, when executed by the processor, further cause the system to:
scan the code using the user device to take ownership of the item; and
apply for a warranty with a single button click of the user device.

7. The system of claim 3, wherein the instructions, when executed by the processor, further cause the system to:
scan the code using the user device to initiate at least one of a product review or complaint of the item.

8. The system of claim 3, wherein the instructions, when executed by the processor, further cause the system to:
receiving item-specific notifications such as recall notices on the user device.

9. The system of claim 3, wherein the unique identifier includes a GUID (globally unique identifier).

10. The system of claim 1, wherein the instructions, when executed by the processor, further cause the system to:
upload to a database a time of the scan, a location of the scan, and the unique identifier of the scanned scannable code, wherein the scannable code is associated with a first item;
scan a second item associated with the same scannable code by a user device; and
provide an warning that the same scannable code was associated with a first item.

11. A computer-implemented method for determining authenticity of an item, the computer-implemented method comprising:
assigning a unique identifier to an item;
generating a digital signature of the unique identifier of the item using a private key of a producing organization;
generating a scannable code based on at least one of the generated digital signature or a base 64 encoded form of the generated digital signature; and
embedding in the item the scannable code and at least one of the unique item identifier, a name of the producing organization, or a public key server URL.

12. The computer-implemented method of claim 11, further comprising:
scanning the scannable code by a user device;
downloading the public key of the producing organization from a public key server; and
determining, based on the public key, if the digital signature indicates an authentic item or not an authentic item.

13. The computer-implemented method of claim 12, further comprising:
in a case where the digital signature indicates that the item is authentic, displaying an indication that the item is authentically produced by the producing organization.

14. The computer-implemented method of claim 12, further comprising:
in a case where the digital signature indicates that the item is not authentic, displaying an indication that the item is not authentically produced by the producing organization.

15. The computer-implemented method of claim 11, wherein embedding in the item the scannable code includes at least one of printing the scannable code and/or etching the scannable code on the item and/or on packaging of the item.

16. The computer-implemented method of claim 12, further comprising:
scanning the code using the user device to take ownership of the item; and
applying for a warranty with a single button click of the user device.

17. The computer-implemented method of claim 13, further comprising:
scanning the code using the user device to initiate at least one of a product review or complaint of the item.

18. The computer-implemented method of claim 13, further comprising:
receiving item-specific notifications such as recall notices on the user device.

19. The computer-implemented method of claim 11, wherein the unique identifier includes a GUID (globally unique identifier).

20. A non-transitory computer-readable medium storing instructions that, when executed by a processor, cause the processor to perform a method for determining authenticity of an item, the method comprising:
assigning a unique identifier to an item;
generating a digital signature of the unique identifier of the item using a private key of a producing organization;
generating a scannable code based on at least one of the generated digital signature or a base 64 encoded form of the generated digital signature; and
embedding in the item the scannable code and at least one of the unique item identifier, a name of the producing organization, or a public key server URL.
